(19) United States
(12) Patent Application Publication
(10) Pub. No.: US 2026/0055789 A1
(43) Pub. Date: Feb. 26, 2026

(54) HOOK SCREW HANGER AND HOOK NAIL HANGER

(71) Applicant: Howard Lee Gatch, III, Charleston, SC (US)

(72) Inventor: Howard Lee Gatch, III, Charleston, SC (US)

(21) Appl. No.: 19/206,410

(22) Filed: May 13, 2025

Related U.S. Application Data
(62) Division of application No. 19/029,776, filed on Jan. 17, 2025.
(60) Provisional application No. 63/563,806, filed on Mar. 11, 2024.

(51) Int. Cl. F16B 35/06; F16B 15/02; F16B 15/06; F16M 13/02

(52) U.S. Cl. CPC F16B 35/06; F16B 15/02; F16B 15/06; F16M 13/02

(57) ABSTRACT

The hook screw hanger and hook nail hanger have a shaft with an O-shaped eye or a triangularly shaped element (both finger engaging elements) which extend laterally away from the hook screw self-tapping screw threads or the hook nail shaft. Hook screw heads have either a lateral straight head channel (for a straight edge screwdriver) or an X-channeled screw head (for a Phillips head screwdriver). Hook nail has a hammer strike head. The eye or triangle engagement elements are proximate to the screw head or nail head. An inverted L-shaped hanger bar extends laterally from the screw/nail shaft, opposite the O or triangle engagements and is proximate the screw/nail head. In one embodiment, the nail shaft has an upper and a lower outboard extending circumferential stops on the nail shaft to enable removal of the nail hook by a hammer claw.

### CROSS-REFERENCE TO RELATED APPLICATION

This is a divisional patent application based upon and claiming the benefit of U.S. patent application Ser. No. 19/029,776, filed Jan. 17, 2025, now pending, and U.S. Provisional Patent Application Ser. No. 63/563,806 filed Mar. 11, 2024, the contents of which is incorporated herein by reference thereto. The present invention relates, in one embodiment, a hook-carrying screw (otherwise referred to as a “hook screw”) and, in another embodiment, a hook-carrying nail (otherwise referred to as a “hook nail”).

### BACKGROUND OF THE INVENTION

Current prior art hook screws have, at one longitudinal end, a series of self-threading or self-tapping screw threads, and have, at the other longitudinal end either a “hook” (which is U-shaped wherein the open mouth of the U-shape permits the user to hang something in the U-shaped element) or has an eye formed as a generally closed circular element (which permits the user to thread something through the O-shaped, generally closed circular element).

These prior art hook screws require the user to either drill a starting hole in the ceiling or the wall or use a nail to form the starting hole in the ceiling or the wall. Thereafter, the user grasps the prior art U-shaped hook or the prior art O-shaped element and simultaneously forces the screw threads into the starting hole while turning the hook screw to engage the self-tapping feature of the screw threads.

The invention eliminates the simultaneous force-and-screw on the hook/O-shaped element of the prior art hook screw. The same issues and problems apply to prior art nails with hooks or O-shaped elements on the nail head.

### SUMMARY OF THE INVENTION

Instead, the hook screw invention replaces that force-and-screw step with a screw head at the screw terminal end configured to enable the user to engage the self-tapping feature with either a straight edge screwdriver or X-shaped Phillips head screwdriver. The invention has a screw head to engage, in a complementary manner, either a straight edge screwdriver or X-shaped Phillips head screwdriver with a straight lateral channel (complementary to the straight edge screwdriver) or an X-shaped channel (complementary to the X-shaped Phillips head screwdriver). These complementary screw head channels are formed at the terminal end of the hook screw, opposite the self-tapping screw threads.

The hook nail permits the user to partly screw-in the hook nail shaft and then tap the hook nail head to force the hook nail into the wall or ceiling. The finger engagements at the top of the hook nail head facilitate that pre-nailing insertion. This also is an improvement over the prior art nail systems.

With the foregoing and other objects in view, there is provided, in accordance with the invention, a hook screw hanger which includes an elongated shaft having screw thread partly extending up the shaft from a terminal shaft end. The shaft has a top terminal screw end with either (i) a lateral channel adapted to coact with a straight edge screwdriver or (ii) an X-shaped Phillips head screwdriver channel adapted to coact with a Phillips head screwdriver.

Another feature of the present invention is the combination of an inverted L-shaped hanger bar and either (i) O-shaped finger or thumb engaging element or (ii) a lateral triangle-type finger or thumb engaging element laterally extending opposite the L-hanger bar. The inverted L-shaped hanger bar is formed by a lateral hanger leg laterally extending from the hook screw shaft proximate the top screw terminal end and is further formed by a base leg longitudinally disposed in the same longitudinal direction as the shaft. The O-shaped finger or thumb engaging element laterally extending opposite the hanger bar on the shaft. The lateral triangle-type finger or thumb engaging element also laterally extends opposite the hanger bar on the shaft.

In accordance with another feature, an embodiment of the present invention includes a screw thread which is self-tapping screw thread. Additional features of the invention include either the O-shaped engaging element or the triangle-type engaging element extending both laterally from the hook screw shaft and partially longitudinally extending in the same longitudinal direction as the shaft. Each respective terminal end of the O-shaped engaging element or the triangle-type engaging element is spaced away the shaft by a gap space.

A further feature of the present invention is an L-shaped hanger with a terminal end, foreshortened lateral tail extending inboard towards the hook screw shaft.

The nail hook hanger invention includes an elongated nail shaft having a pointed terminal end and an opposing hammer strike head. The inverted L-shaped hanger bar, similar to the hanger bar on the screw hook, is formed by a lateral hanger leg laterally extending from the nail shaft proximate the strike head. The hanger bar is further formed by a base leg longitudinally disposed in the same longitudinal direction as the nail shaft. Either an O-shaped finger or thumb engaging element or a lateral triangle-type finger or thumb engaging element laterally extends opposite the hanger bar on the nail shaft.

Additional features of the nail hook hanger include a grooved nail shaft along and about the lower shaft portion. The O-shaped engaging element or the triangle-type engaging element extends both laterally from the nail shaft and partially longitudinally in the same longitudinal direction as the nail shaft. The terminal ends of either the O-shaped engaging element or the triangle-type engaging element are spaced away the nail shaft by a gap space. Another aspect of the nail hook hanger is a foreshortened lateral tail at the terminal end of L-shaped hanger. This foreshortened lateral tail extends inboard towards the nail shaft.

An additional embodiment of the nail hook hanger invention has upper and lower outboard extending circumferential stops on the nail shaft. The stops are longitudinally disposed on the nail shaft intermediate the pointed terminal nail end and a terminal end of the O-shaped engaging element or a terminal end of the triangle engagement element. These stops are used to remove the nail hook hanger from the wall or ceiling.

Although the invention is illustrated and described herein as embodied in a hook screw or a hook nail, it is, nevertheless, not intended to be limited to the details shown because various modifications and structural changes may be made therein without departing from the spirit of the invention and within the scope and range of equivalents of the claims. For example, although the inventions are described as being attached to a wall or ceiling, the hanger system can be used in connection with any type of structure. Additionally, well-known elements of exemplary embodiments of the invention will not be described in detail or will be omitted so as not to obscure the relevant details of the invention.

Other features that are considered as characteristic for the invention are set forth in the appended claims. As required, detailed embodiments of the present invention are disclosed herein; however, it is to be understood that the disclosed embodiments are merely exemplary of the invention, which can be embodied in various forms. Therefore, specific structural and functional details disclosed herein are not to be interpreted as limiting, but merely as a basis for the claims and as a representative basis for teaching one of ordinary skill in the art to variously employ the present invention in virtually any appropriately detailed structure. Further, the terms and phrases used herein are not intended to be limiting; but rather, to provide an understandable description of the invention. While the specification concludes with claims defining the features of the invention that are regarded as novel, it is believed that the invention will be better understood from a consideration of the following description in conjunction with the drawing figures, in which like reference numerals are carried forward. The figures of the drawings are not drawn to scale.

Before the present invention is disclosed and described, it is to be understood that the terminology used herein is for the purpose of describing particular embodiments only and is not intended to be limiting. The terms “a” or “an,” as used herein, are defined as one or more than one. The term “plurality,” as used herein, is defined as two or more than two. The term “another,” as used herein, is defined as at least a second or more. The terms “including” and/or “having,” as used herein, are defined as comprising (i.e., open language). The term “coupled,” as used herein, is defined as connected, although not necessarily directly, and not necessarily mechanically. The term “providing” is defined herein in its broadest sense, e.g., bringing/coming into physical existence, making available, and/or supplying to someone or something, in whole or in multiple parts at once or over a period of time.

In the description of the embodiments of the present invention, unless otherwise specified, azimuth or positional relationships indicated by terms such as “up”, “upper,” “down,” “lower,” “left,” “right,” “inside,” “outside,” “front,” “back,” “head,” “tail” and so on, are azimuth or positional relationships based on the drawings, which are only to facilitate description of the embodiments of the present invention and simplify the description, but not to indicate or imply that the devices or components must have a specific azimuth, or be constructed or operated in the specific azimuth, which thus cannot be understood as a limitation to the embodiments of the present invention. Furthermore, terms such as “first,” “second,” “third,” and so on are only used for descriptive purposes and cannot be construed as indicating or implying relative importance. The term “lateral” refers to a positional aspect normal or perpendicular to another positional aspect such as a “longitudinal” element.

As used herein, the terms “about” or “approximately” apply to all numeric values, whether or not explicitly indicated. These terms generally refer to a range of numbers that one of skill in the art would consider equivalent to the recited values (i.e., having the same function or result). In many instances, these terms may include numbers that are rounded to the nearest significant figure. In this document, the term “longitudinal” should be understood to mean in a direction corresponding to an elongated direction of the screw shaft of the hook screw or the nail shaft of the hook nail.

Conjunctive language such as the phrase “at least one of X, Y, and Z,” unless specifically stated otherwise, is otherwise understood with the context as used in general to convey that an item, term, etc. may be either X, Y, or Z. Thus, such conjunctive language is not generally intended to imply that certain embodiments require at least one of X, at least one of Y, and at least one of Z to each be present.

### BRIEF DESCRIPTION OF THE DRAWINGS

The accompanying figures, wherein like reference numerals refer to identical or functionally similar elements throughout the separate views, when taken together with the detailed description below, are incorporated in and form part of the specification. The figures or drawings serve to further illustrate various embodiments and explain various principles and advantages all in accordance with the present invention.

FIGS. 1A and 1B show a straight edge channeled hook screw 10 (FIG. 1A) and X-channeled hook screw 12 (FIG. 1B).

FIG. 2 shows a front side view of the hook screw 10 (the rear view is identical to the front view).

FIG. 3 shows a front side view of the hook screw 12 (the rear view is identical to the front view).

FIG. 4 shows a left side view of either hook screws 10, 12 because the longitudinal extent of both the O-shaped element 18 and the triangle element 19 of hook screws 10, 12 terminate at the same longitudinal position with respect to the self-tapping screw thread.

FIG. 5 shows a right side view of either hook screw 10, 12.

FIGS. 6-9 show hook nails 30, 32, 40 and 42. Similar to the hook screw hanger, the hook nail hangers 30, 40 in FIGS. 6 and 8 have an O-shaped eye 18 formed as a generally closed circular element. Hook nail hangers 32, 42 in FIGS. 7 and 9 have a triangularly shaped, generally closed element 19, sometimes referred to herein as triangle 19.

FIG. 10 shows a hammer claw removing the hook nail hanger from a wall, ceiling or any other type of flat surface.

### DETAILED DESCRIPTION

While the specification concludes with claims defining the features of the invention that are regarded as novel, it is believed that the invention will be better understood from a consideration of the following description in conjunction with the drawing figures, in which like reference numerals are carried forward. It is to be understood that the disclosed embodiments are merely exemplary of the invention, which can be embodied in various forms.

In general, the hook screw hanger has two (2) embodiments and each includes self-taping screw heads at one longitudinal end portion and have a screw head at the other, top terminal screw end with either a common lateral channel for straight edge screwdriver or an X-shaped Phillips head screwdriver channel. Both embodiments of the hook screw have an L-shaped laterally extending bar element. One hook screw embodiment has an opposing lateral extension formed as a lateral O-shaped finger or thumb engaging element and another hook screw embodiment has a lateral triangle-type finger or thumb engaging element. The O-shaped finger-thumb engagement and the triangle finger-thumb engagement extend laterally opposite the L-shaped laterally extending bar element.

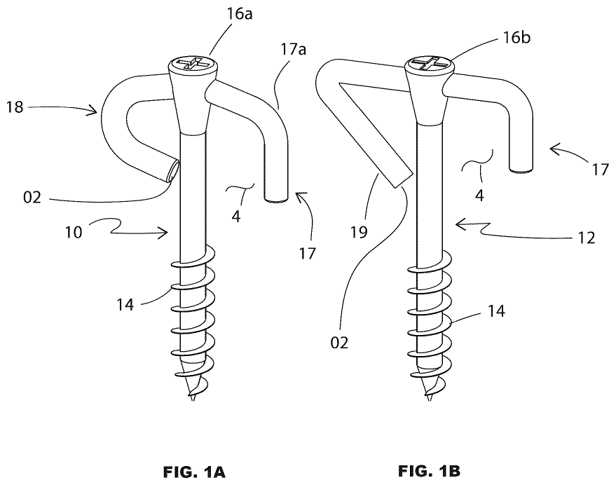

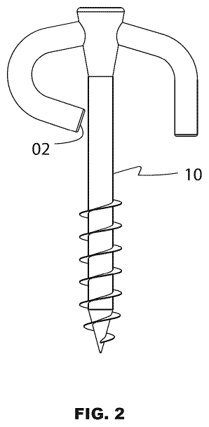

FIGS. 1A and 1B show a straight edge channeled hook screw hanger 10 and X-channeled hook screw 12. Screw head 16a in FIG. 1A includes a straight edge channeled screw head which is complementary to a straight edge screwdriver. Screw head 16b in FIG. 1B includes an X-channeled screw head which is complementary to an X-shaped Phillips head screwdriver.

Hook screw 10 has an eye 18 formed as a generally closed circular element. There is a small gap 2 between the terminal end of the eye 18 and the smooth shaft portion of the screw. Hook screw 12 has a triangularly shaped, generally closed element 19, sometimes referred to herein as “triangle” 19. The terminal end of the triangle also has a small gap 2 between its terminal triangle end and the screw shaft. Eye 18 and triangle 19 extend laterally away from the longitudinal, self-tapping screw threads 14 and portions of eye 18 and triangle 19 extend longitudinally in the direction of screw threaded shaft 14. Eye 18 has a lateral element perpendicular to the screw shaft. Triangle 19 also has a lateral element perpendicular to the screw shaft.

It should be noted that hook screws 10, 12, may have either a lateral straight head channel for a straight edge screwdriver or an X-channeled screw head for a Phillips head screwdriver. Hence the O-shaped ring-like or eye element 18 hook screw may have an X-channel (for the Phillips head screwdriver) and the triangle-shape element 19 may have a laterally straight channel (for the straight edge screwdriver).

Both hook screws 10, 12 in FIGS. 1A and 1B have, opposite the O-shaped engagement element 10 or the triangle engagement element 19, an inverted L-shaped hanger bar 17 wherein a laterally extending leg element of the L-shaped bar 17 extends opposite the laterally extending O element 18 or triangle element 19, and the other portion of the L-shaped element (the base leg 17a of the L-shape) is longitudinally disposed in the same longitudinal direction as the self-tapping screw thread. The O element 18 or the triangle element 19 and this base leg of the L-shape extend towards the self-tapping terminal threads 14. Preferably, O/triangle engagement elements lie in the same imaginary plane as the L-shaped hanger bar 17. This facilitates the manual insertion and removal of the screw hook hanger from the wall or ceiling.

FIG. 2 shows a front side view of the hook screw 10 and the rear view is identical to the front view. It should be noted that the screw head in FIG. 2 is conically shaped to provide a larger platform for the straight receiving channel (for a straight head screwdriver) or the X-shaped receiving channel (for the Phillips head screwdriver).

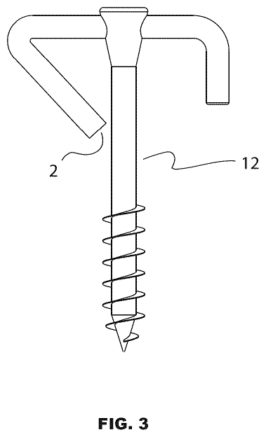

FIG. 3 shows a front side view of the hook screw 12 and the rear view is identical to the front view.

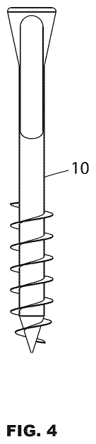

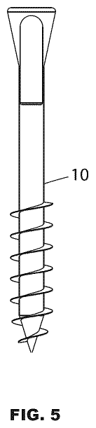

FIG. 4 shows a left side view of either hook screws 10, 12 because the longitudinal extent of both the O-shaped element 18 and the triangle element 19 terminates at the same longitudinal position with respect to the self-tapping screw thread. FIG. 5 shows a right side view of either hook screws 10, 12.

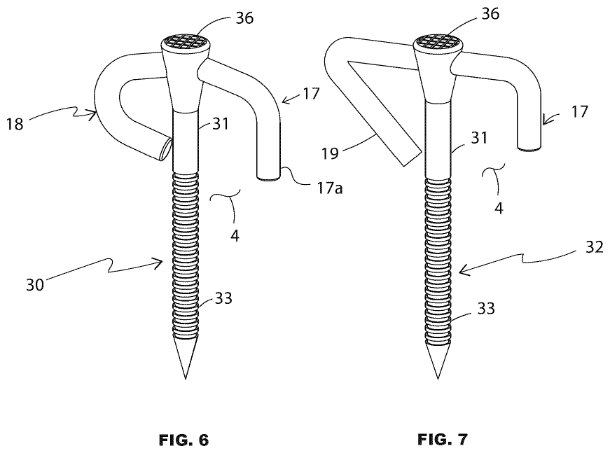

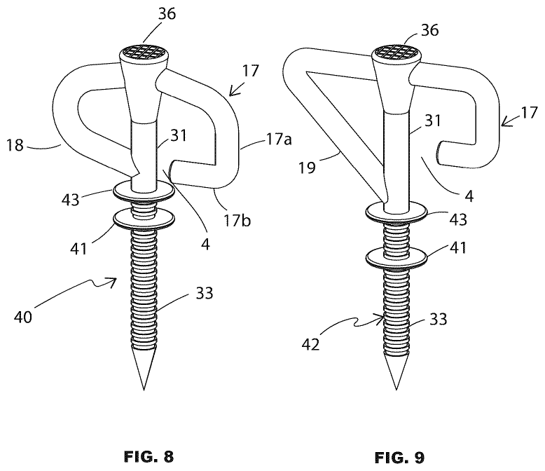

The present invention also relates to a hook-carrying nail (otherwise referred to as a “hook nail”). In general, the hook nail hanger has two (2) embodiments and each includes an L-shaped laterally extending bar element. One set of hook nail embodiments in FIGS. 6 and 8 has an opposing lateral extension formed as a lateral O-shaped finger or thumb engaging element and another set of hook nail embodiments in FIGS. 7 and 9 has a lateral triangle-type finger or thumb engaging element. The O-shaped finger-thumb engagement and the triangle finger-thumb engagement extend laterally opposite the L-shaped laterally extending hanger bar element 17. In preferred embodiments, the terminal end of the O-shaped eye 18 is gap-spaced away from the shaft as is the terminal end of the triangle 19 (that is, gap-spaced apart from the shaft).

FIGS. 6-9 show hook nail hangers 30, 32, 40 and 42. Each hook nail 30, 32, 40 and 42 has a hammer strike head 36 which optionally includes small cross-serrations on the head surface. Similar to the hook screw, the hook nails 30, 40 have an eye 18 formed as a generally closed circular element. Hook nails 32, 42 have a triangularly shaped, generally closed element 19, sometimes referred to herein as triangle 19. Eye 18 and triangle 19 extend laterally away from the longitudinal nail shaft 33. Nail shaft 31 may have grooves.

Hook nails 30, 32, 40 and 42 each have a nail shaft 31 and a grooved or somewhat threaded lower shaft 33 which increases pull-out force needed to remove the hook nail from the wall or ceiling.

Hook nails 30, 32, 40 and 42 have, opposite the O-shaped eye element 18 or the triangle 19, an inverted L-shaped bar 17 wherein a laterally extending leg element of the L-shaped bar 17 extends opposite the laterally extending O engagement element 18 or triangle engagement element 19 (that is, normal to the nail shaft), and the other portion of the L-shaped element 17 (the base leg 17a of the L-shape) is longitudinally disposed in the same longitudinal direction as the nail shaft 33. The O element 18 or the triangle element 19 and this base leg of the L-shape extend towards the pointed terminal end of nail shaft 33.

FIGS. 6 and 8 show the hook nail 30 with O-shaped eye 18. FIGS. 7 and 9 show the hook nail with triangle 19. FIGS. 6 and 7 show a hook nail without any shaft stops 41, 43.

FIGS. 8 and 9 show the nail shaft 31 with an outboard extending lower circumferential stop element 41 and an outboard extending upper circumferential stop element 43. The stops 41, 43 are longitudinally disposed apart on the nail shaft. The stops are intermediate the pointed terminal nail end and the lower terminal end of the O-shaped eye 18 or the lower terminal end of the triangle engagement elements 18, 19.

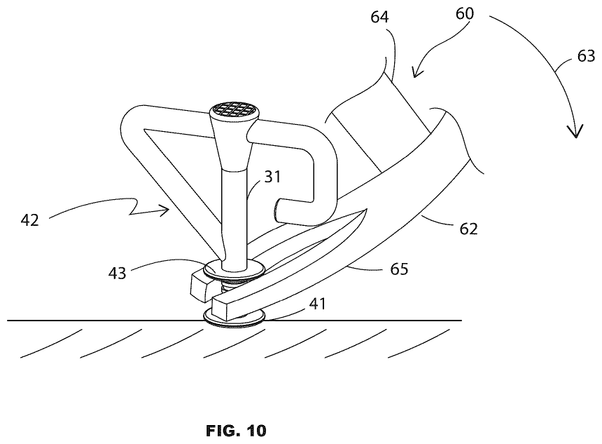

FIG. 10 shows a hammer 60 removing the hook nail from a wall, ceiling or flat surface. To remove the hook nails in FIGS. 6 and 7 from a wall or ceiling embedded condition, the user pulls the hook nail from the wall or ceiling by placing the hammer head 62 on the wall or ceiling surface and the hammer claw 65 adjacent eye 18 or triangle 19. The open jaw of the hammer claw 65 is placed intermediate the upper and lower nail stops. To remove the hook nails in FIGS. 8 and 9 from a wall or ceiling embedded condition, the user pulls the hook nail 40, 42 from the wall or ceiling by placing the hammer head 62 on the wall or ceiling surface and the open jaw of hammer claw 65 between the upper and lower stops 41, 43. The user then rotates handle 64 of hammer 60 in the direction of arrow 63 to pull the hook nail from the wall or ceiling or surface.

As an example, the hook screw hanger 10, 12 and hook nail hanger 30, 32, 40 and 42, when in use and attached to a ceiling surface, the “inverted L-shape” hanger 17 has a hanger space 4 which enables the user to place a loop or ring on the inboard surface of the lateral extension of the hanger 17 such that items connected or coupled to the loop or ring hang from the wall or ceiling. The same hanging position can be achieved by attaching the hook screw hanger 10, 12 and hook nail hanger 30, 32, 40 and 42 to a wall.

Removal of the hook screw 10 and 12 in FIGS. 1A and 1B is enabled by the user counter rotating the shaft of hook screw 10, 12 and by applying force to the O-shaped eye 18 or the triangular element 19.

In FIGS. 8 and 9, the terminal end of L-shaped hanger 17 has a foreshortened lateral tail 17b normal to the base leg 17a of hanger 17 which, in some situations, better secures items hung on a wall or ceiling. The hanger 17 of hook screw hangers 10, 12 and hook nail hangers 30, 32, 40 and 42 may have a foreshortened lateral tail 17b normal to the base leg 17a. The foreshortened lateral hanger tail 17b extends inboard towards to the screw shaft 14 or the nail shaft 31.

The claims appended hereto are meant to cover all modifications and changes within the scope and spirit of the present invention.

What is claimed is:

1. A hook nail hanger comprising:
an elongated nail shaft having a pointed terminal end and an opposing hammer strike head;
an inverted L-shaped hanger bar formed by a lateral hanger leg laterally extending from the nail shaft proximate the strike head and formed by a base leg longitudinally disposed in the same longitudinal direction as the nail shaft; and
either O-shaped finger or thumb engaging element or a lateral triangle-type finger or thumb engaging element laterally extending opposite the hanger bar on the nail shaft.

2. The hook nail hanger as claimed in claim 1 wherein the nail shaft has a grooved threaded lower shaft portion.

3. The hook nail hanger as claimed in claim 2 wherein either the O-shaped engaging element or the triangle-type engaging element extends both laterally from the nail shaft and partially longitudinally in the same longitudinal direction as the nail shaft.

4. The hook nail hanger as claimed in claim 3 wherein a respective terminal end of either the O-shaped engaging element or the triangle-type engaging element is spaced away the nail shaft by a gap space.

5. The hook screw hanger as claimed in claim 4 wherein a terminal end of L-shaped hanger has a foreshortened lateral tail extending inboard towards the nail shaft.

6. A hook nail hanger comprising:
an elongated nail shaft having a pointed terminal end and an opposing hammer strike head;
an inverted L-shaped hanger bar formed by a lateral hanger leg laterally extending from the nail shaft proximate the strike head and formed by a base leg longitudinally disposed in the same longitudinal direction as the nail shaft;
either O-shaped finger or thumb engaging element or a lateral triangle-type finger or thumb engaging element laterally extending opposite the hanger bar on the nail shaft; and
an upper and a lower outboard extending circumferential stop on the nail shaft.

7. The hook nail hanger as claimed in claim 6 wherein the stops are longitudinally disposed on the nail shaft intermediate the pointed terminal nail end and a terminal end of the O-shaped engaging element or a terminal end of the triangle engagement element.

8. The hook nail hanger as claimed in claim 7 wherein the nail shaft has a grooved threaded lower shaft portion.

9. The hook nail hanger as claimed in claim 8 wherein either the O-shaped engaging element or the triangle-type engaging element extends both laterally from the nail shaft and partially longitudinally in the same longitudinal direction as the nail shaft.

10. The hook nail hanger as claimed in claim 9 wherein a respective terminal end of either the O-shaped engaging element or the triangle-type engaging element is spaced away the nail shaft by a gap space.

11. The hook screw hanger as claimed in claim 10 wherein a terminal end of L-shaped hanger has a foreshortened lateral tail extending inboard towards the nail shaft.
